(19) United States
(12) Patent Application Publication
(10) Pub. No.: US 2006/0117173 A1
(43) Pub. Date: Jun. 1, 2006

(54) Method and system for the secure transmission of a confidential code through a telecommunication network

(76) Inventors: Alain Deblock, Versailles (FR); Thibault Behaghel, Boulogne (FR); Francois De Chabannes, Versailles (FR); Denis Jeanteur, Issy-les-Moulineaux (FR)

Correspondence Address: YOUNG & THOMPSON, 745 SOUTH 23RD STREET, 2ND FLOOR, ARLINGTON, VA, 22202, US

(21) Appl. No.: 10/524,772

(22) PCT Filed: Aug. 14, 2003
(86) PCT No.: PCT/FR03/02536

§ 371 Date: Feb. 16, 2005

(30) Foreign Application Priority Data
Aug. 16, 2002 (FR) 02/10367

(51) Int. Cl. H04L 9/00

(52) U.S. Cl. 713/150; 713/182

(57) ABSTRACT

A method for the secured and automated transmission of confidential information, in particular an identification code to an authentication body (3) during a transaction with a user (1). The method includes transmitting a first part of confidential information to the authentication body through a first network and is characterised in that in the first stage, the user (1) transmits a second part of confidential information complementary to the first part thereof to a neutral intermediate party (4) through a second network (200) disjointed from the first network, afterwards, the neutral intermediate party (4) transmits the received complementary part of confidential information to the authentication body (3) through a third network (300).

### GENERAL TECHNICAL FIELD.

The invention relates to an automated method for the secure transmission of confidential information, optionally incorporating identification codes, over two disjointed and optionally insecure telecommunication networks, in particular Internet and the telephone network.

More precisely, the invention relates to a method avoiding the transit, storage and reconstitution of confidential information, in its entirety, even transiently, by one or more intermediaries between a sender and a recipient of said confidential information.

The method also allows a neutral intermediary to construct a trace of the history of the use of the confidential information, anonymously and yet still being unable to reconstitute it in its entirety.

The invention is particularly suitable for transmitting a payment card or authentication code for securing payments, principally for confidential remote access, by transmitting a password or equivalent.

### STATE OF THE ART

Transmitting confidential information, in particular identification codes, over public networks and particularly payment card numbers or passwords, is essential for finalizing remote transactions, in particular commercial, or to identify oneself, over said networks.

Users, in particular on-line consumers, are of course reluctant to transmit confidential information, in particular their payment card number or passwords, over the Internet or over another telecommunication network. Such reluctance is a significant brake on the growth of transactions, in particular commercial, over these networks.

Users' fears are in particular:

on the one hand, the fear that their confidential data will be pirated via eavesdropping on the network during the transmission of said confidential information from the sender to the recipient. Pirating may also be carried out by a third party which would thus recover the confidential information;

on the other hand, the fear of pirating of confidential information on the server of an intermediary, for example a service provider, a dealer, or a trusted third party, or simply by the dishonesty of said intermediary.

Both these fears are summed up by the apprehension that ill-intentioned persons could re-use this confidential information, for example a payment card number or a password, to impersonate the genuine user.

Thus, despite the installation of systems to encrypt data during its transfer, the mistrust remains.

Moreover, in the case of on-line purchases, for example, the fears of on-line goods or service providers are in particular:

on the one hand, the fear of excessive rejections of on-line purchases due to fraud, and sometimes to the dishonesty of certain users, in particular on-line consumers;

on the other hand, the fear of attacks on their servers, by ill-intentioned third parties who want to recover all sorts of identifying information, such as passwords or payment card numbers. Security measures are never sufficient and thousands of payment card numbers, passwords, and every kind of confidential information available on a server are a very attractive target for intruders.

The solutions provided for this problem are of three types:

either data encryption, at least during transmission, via protocols or, optionally, various hardware well known to a person skilled in the art, for example, but not limited to, the SSL or “Secure Socket Layer” transaction protocol or TLS “Transport Layer Security” according to the English terminology generally used by a person skilled in the art, the SSL and TLS protocols themselves using various ciphering algorithms, authentication protocols and certificate generation systems.

or authentication methods with prior registration with a trusted third party or equivalent, and which generally require the disclosure of personal information. The user must then be confident in the ability of these service providers and intermediaries to ensure authentication security. Such examples of methods are disclosed in the documents U.S. Pat. No. 6,012,144 and FR 2 806 229, for example.

or methods termed ‘proprietary’, which require loyalty by both buyer and seller to a technical system, for example a card reader or proprietary key generation systems, and which require installation of a software programme, plug-in or hardware item. This is in particular the case in the method disclosed in the document WO 96/29667.

Early encryption solutions did not respond to user fears as only the transmission is secure and their confidential information always circulates as a part (even if, for example, the Internet protocol breaks down the information into packets, the latter being reconstituted and reconstitutable) and are stored as a single part. For example, the SSL secure transmission protocol provides good data transmission protection but, on the one hand it is not impossible to decrypt the SSL secure data transmission and, on the other hand, it leaves the problem of sending and receiving the data untouched. Furthermore, users do not necessarily acknowledge the security of the system, as it has been shown, in particular on the Internet, that such systems, based on the entire transmission and by one or more channels using identical technology, were a source of fraud.

The second type of solution, involving pre-registration, are unsuited to the user, as they are not universal and require him to make the effort of registering. The second type of solution is no longer suited to suppliers of goods and services which seek solutions where the flow is uninterrupted, i.e. the transaction is fluid, in particular for the user.

Finally, solutions of the third type require a wholesale enrolment effect, in particular from consumers and frequently, they also require an investment in money or time by the user to master the installation or use. Finally, these solutions have frequently also proved very costly for the service provider, dealer or authenticating organization.

Moreover, it has been noted that sending confidential information by fax, telephone, SMS, mail or other means of remote communication, electronic or other, reassures some users although the risk of pirating confidential information in these cases is very high and that these solutions do not resolve the information storage problem.

In conclusion, sending confidential information over a network carries a risk during the following stages:
entering this information on a single terminal, as the terminal (keyboard, screen, etc.) may be spied upon;
transmission over the network, in particular the start and finish, as the information, even encrypted, can be captured then either be reused directly or decrypted;
the storage of this confidential information with an intermediary, a trusted third party or supplier of goods or services, as this server may be a weak point in the security, despite the precautions taken and even if an encryption algorithm, especially if it is of the reversible type, is applied;
the registration phases are particularly vulnerable, as in addition to the confidential information, personal information is frequently sent.

### PRESENTATION OF THE INVENTION.

The invention proposes to overcome the drawbacks set out earlier.

An aim of the invention is to ensure the transmission of confidential information which does not detract from the smooth flow of the transaction and is very user-friendly.

Another aim of the invention is to propose a technique for guiding the user through the various stages of sending the information.

Another aim of the invention is to provide a method which does not require prior registration with the neutral intermediary providing anonymous transfer of at least one part of the confidential information. It is therefore partially opposed to the concept, familiar to a person skilled in the art, of the ‘trusted third party’ in the sense that the trusted third party is frequently the depositary of personal information which may also be very confidential.

Another aim of the invention is to provide a method which does not intrinsically require special facilities for the user, other than the software, hardware and means of communication over the networks implemented during the transaction. Hence the securing of the transaction is not carried out to the detriment of the smooth flow of the transaction.

Another aim of the invention is to allow improved identification of the user while the confidential information is being sent, while at the same time maintaining simplicity of use and ensuring the user remains anonymous.

According to this invention, the security is ensured by separating the information into two complementary parts which are insignificant when separated, transported over two disjointed networks via a neutral intermediary and requiring neither registration of the user with said neutral intermediary, nor installation by the user of software and hardware other than those necessary for connection over the two telecommunication networks.

To this end, the invention proposes a method for secure transmission of confidential information, in particular an identification code, to an authenticating organization or any other end recipient, termed “authentication organization”, and authorized to receive this information during a transaction with a user. This method is characterized in that the user separates the confidential information which he wants to send to the authentication organization into two complementary parts which are valueless taken separately.

This uses a disjointed security technique allowing simultaneous and entirely automated transmission of two complementary parts of an item of confidential information over two different networks. This technique is a very sure means of transmitting confidential information if the parts are valueless taken separately and if it is impossible for a third party to reassemble the parts, which is enabled by the method implemented by the invention.

The method implemented by the invention sets up an intermediary, called “neutral intermediary”, which sends anonymously and without storing the data capable of being reconstituted, a part of the confidential information which is not usable on its own, in particular an identification code, via a network called “the second network”, technologically distinct from the network called “the first network”, which is used to send the other complementary part of said confidential information directly or indirectly to the authenticating organization.

In this method, the data stored by the neutral intermediary is stored using non-reversible encryption techniques called “digital fingerprinting”, which is well known to a person skilled in the art, such as the MD5 algorithm (“Message Digest 5” using English terminology and referenced RFC1321) or the SHAL algorithm (“US Secure Hash Algorithm 1” using English terminology and referenced RFC3174), or any other one-way encryption algorithm. Thus the neutral intermediary cannot reconstitute the information which it is storing. This ‘anonymous identification’ is carried out by comparing the stored digital fingerprints with the digital fingerprint for a combination identical to that of the data transmitted. This allows the method to construct an anonymous record of the transactions by storing, for example, the digital fingerprint of a combination of the user's details on the second network with the supplementary part of the confidential information also received by the neutral intermediary over the second network. Statistical data of every kind may be associated to said fingerprint for the purposes of classification, analysis and scoring.

The user sends a first part of the confidential information either directly to the authenticating organization, or via an intermediary, for example, a supplier of goods or services over a first network, for example, the Internet.

At the request of the neutral intermediary, itself requested directly or indirectly by the authenticating organization, the user then sends the second complementary part of the confidential code to the neutral intermediary over a second network disjointed from the first, using, for example, different communication technologies or protocols, the neutral intermediary then sending the part of the code which it has received to the authenticating organization.

Exchanges with the authenticating organization and, if necessary, with the suppliers of goods or services party to the transaction with the user are secured point to point by coding and mutual recognition techniques familiar to a person skilled in the art, such as the exchange of certificates or keys, SSL transmission, TLS, etc. This secure network between two points is called the “third network”. The first and second networks are networks connected to the user, whereas the third network is a network between the neutral intermediary, the authenticating organization and, optionally, suppliers of goods and services party to the transaction.

This separation of the information into two complementary parts, transmitted via disjointed communication channels and different technologies, such as the Internet and the telephone, is easily understood by the user, who sends a part of his confidential information via distinct telecommunication means. Of course, he is reassured by this.

The two networks have disjointed data entry means, which may be, for example, but not limited to, a computer keyboard, the keys on a telephone, a voice recognition system, a card reader, etc. This avoids pirating or monitoring of the data input by a unique terminal and in particular a computer keyboard.

The invention is advantageously complemented by the following characteristics, taken individually or in any of their combinations as technically feasible:

transmission of the first part of the confidential information to the authenticating organization is carried out according to the following stages:

the user sends the first part of the confidential information to a supplier of goods or services over the first network;

the supplier then sends the first part to the organization over a third network;

at least one session identifier, shared between at least two of the parties to the transaction, allows the authenticating organization to reconstitute automatically the confidential information which the user sends to it;

each session identifier is generated by at least one of the parties to the transaction;

the neutral intermediary contacts the user over the second network automatically, in order to retrieve the second complementary part of the confidential information;

the communication over the first network between the user and the authenticating organization or the supplier of goods or services is transferred automatically to the neutral intermediary for the transaction;

the user contacts the neutral intermediary over the network in order to send the second complementary part of the confidential information associated with a session identifier;

recall coordinates of the user over the second network are sent to the neutral intermediary by the authenticating organization over the third network;

recall coordinates of the user over the second network are sent to the neutral intermediary by the supplier of goods or services over the third network;

recall coordinates of the user over the second network are sent to the neutral intermediary by the user over the first network;

the third network is a secure point to point network;

the user is guided automatically by the neutral intermediary through the various stages of the method for sending the second part of the confidential information over the first and/or second network respectively, in a coordinated and optionally synchronized manner;

the neutral intermediary establishes a transactions log;

the log established by the neutral intermediary is anonymous;

the anonymity of the log is ensured by a non-decipherable coding of a combination of the user's coordinates over the second network and the second part of the confidential information sent by the user to the neutral intermediary over the second network;

the neutral intermediary sends an advice linked to the user's transaction log over the network;

the neutral intermediary requests the user to supply, in addition to the confidential information to be sent to the organization, a personal code which is used during subsequent transactions and which identifies the user;

the personal code is sent via a secure point to point type network to a second authenticating organization with which the user has previously registered or to which the user is known;

the personal code is a digital and/or voice code entered on a terminal connected to the second network;

the neutral intermediary stores, in an uncoded or reversibly encrypted manner, the user's coordinates on the network;

the neutral intermediary stores, in an uncoded or reversibly encrypted manner, the second complementary part of the confidential information supplied by the user over the network;

the neutral intermediary contacts the user again after the latter is disconnected from the first network, said connection to the first network being re-established once the second part of the confidential information has been sent to the neutral intermediary.

The main advantages of the invention are, but not limited to, the following:
securing of the transmission of information via two distinct channels using two disjointed networks implementing, for example, two different communication technologies or protocols,
the engendering in the user the confidence to send confidential information, in particular his payment card number or his password, whilst allowing him to view the process ensuring security,
the ease of use for the user by automating the process and the use of interfaces providing guidance, optionally coordinated over both networks in real time,
securing the entry of confidential information by the use of two disjointed data entry terminals,
identification of the user by connecting means forming the neutral intermediary's server to the user,
the possibility of building up an anonymous transaction log by using digital fingerprinting,
the possibility of a second identification, optionally by a second authenticating organization in order to reinforce the level of identification,
the security and confidentiality of transmissions between the neutral intermediary and the authenticating organization or, optionally, a service provider or dealer by using point to point transmission.

The invention also relates to a system for implementing the method according to the invention.

### PRESENTATION OF THE FIGURES

Other characteristics, objectives and advantages of the invention will emerge from the description which follows, which is purely for illustration and must be read in conjunction with the attached drawings, in which:

FIG. 1 represents diagrammatically the exchanges of information between a user, a supplier of goods or services, for example a dealer, an authenticating organization, for example a bank, and the neutral intermediary;

FIG. 2 represents diagrammatically the various stages of a method for securing exchanges of information between a user, a supplier of goods or services, for example a dealer, an authenticating organization, for example a bank, and the securization intermediary; and

FIG. 3 represents diagrammatically a possible sequence for the various stages of a method for securing exchanges of information between a user, a supplier of goods or services, for example a dealer, an authenticating organization, for example a bank, and the neutral intermediary.

### DETAILED DESCRIPTION

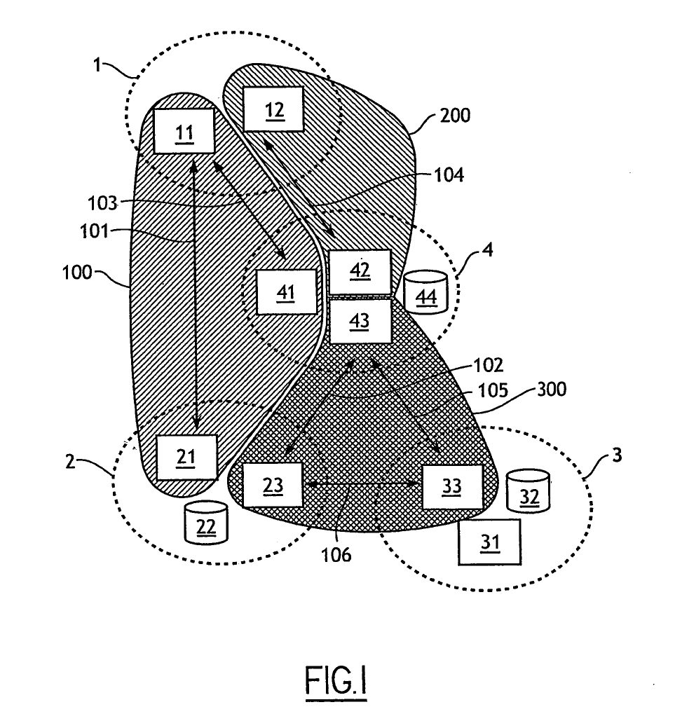

FIG. 1 represents diagrammatically the exchanges of information between a user 1, a supplier of goods or services 2, an authenticating organization 3 and the neutral intermediary 4 during any on-line transaction over a telecommunication network. At this point, it should be noted that the transit of part of the confidential information via the supplier of goods or services is not essential to the transmission of the information. This transmission may be made directly to the authenticating organization. In fact, as the security and anonymity of the transmission is based on exchanges between the user 1, the neutral intermediary 4 and the authenticating organization 3, the channel for transmitting the confidential information from the other party is less important.

FIG. 1 shows the communication networks comprising two disjointed networks and using, for example, different communication technologies or protocols forming the parts 100 and 200, and a point to point private or secure network forming the part 300.

The double arrows 102,105 and 106 symbolize the exchanges of information between the supplier of goods or services 2 and the neutral intermediary 4, the neutral intermediary 4 and the authenticating organization 3, and the supplier of goods or services 2 and the authenticating organization 3 respectively. The link 102 is optional, as all the necessary information for activating the transmission over the second network can transit via the authenticating organization 3.

The first possible part 100 of the telecommunication network allows communication between the user 1 and the supplier of goods or services 2 represented by the double arrow 101, and between the user 1 and the neutral intermediary 4 during exchanges 103. It is preferably of the Internet type and optionally, but not necessarily, secured. The first part 100 may therefore support any type of character which has to be transmitted by the user 1. The first part 100 is necessarily disjointed from the part 200 and uses, for example, different communication technologies or protocols from those used by the part 200.

In the following developments, Internet designates all computer networks 100 from computer terminal to computer terminal. The title specifically includes every kind of private or public network, for example, Intranet or Extranet.

The second possible part 200 of the telecommunication network allows communication between the user 1 and the neutral intermediary 4 during the exchange 104. It is preferably a telephone network. The second part 200 must be disjointed from the part 100 and uses, for example, different communication technologies or protocols from those used by the part 100.

The telephone network is, in the current state of the art, composed essentially of telephone terminals with number keys. Thus, the data sent by the terminals is digital in the current state of the art. Changes in the state of the art may soon allow the transmission of any type of character.

Therefore, at the end of the network 100 situated close to the user 1, the possible system for implementing the method according to the invention comprises, on the one hand, means 11 for connecting to the network 100 and on the other hand, means 12 for connecting to the network 200.

The means 11 communicate with means 21 situated at the supplier of goods or services 2 and means 41 situated at the neutral intermediary 4, in order to allow the exchanges 101 and 103 respectively.

The means 12 communicate with means 42 situated at the neutral intermediary 4, in order to allow the exchanges 104 over the part 200 of the network.

The means 11 comprise, for example, a computer terminal called the “web terminal”, as the network 100 is preferably of the Internet type.

The means 12 comprise, for example, means forming a fixed line telephone connection or a mobile telephone, as the network 200 is preferably a fixed or mobile telephone network.

The telephone 12 is advantageously a key ‘phone and able to send DTMF (Dual Tone Multi-Frequency) codes, according to the English terminology generally used, or any other protocol or method available on said means to send part of the confidential information.

The method according to the invention can thus be transposed to systems which already exist, as mobile ‘phones are able to send DTMF codes and the vast majority of fixed line telephones are key ‘phones and use voice frequencies allowing DTMF codes to be sent.

In the case where the means 12 of user 1 would not allow the transmission of DTMF codes, a variant of the method according to the invention uses voice recognition to acquire the second part of the confidential information.

At the end of the network 100 situated close to the supplier of goods or services 2, the system comprises means 21 forming a server on the network 100. The means 21 comprise, for example, a server called a “web server”.

The supplier of goods or services 2 can thus exchange data 101 with the user 1.

The third part 300 of the telecommunication network is preferably of a type capable of transmitting point to point secure data.

By way of non-limitative example, this may be a network of the VPN (Virtual Private Network) type, a private network, a point to point secured transmission protocol which may use, for example, messages signed by a MAC (Message Authentication Code), which is a seal calculated using an algorithm, for example of the DES (Data Encryption Standard) type and combined with a sealing key exchanged with the data. It can also be SSL or TLS transmissions, with an exchange of certificates between the two parties.

Other point to point secure transaction methods are of course known to a person skilled in the art and may be applicable to the method. Optionally, new security methods can replace currently known protocols.

Therefore, the system at the supplier of goods or services 2 can comprise means 23 capable of managing point to point transactions 102, 106.

Yet again, the method according to the invention can be transposed to prior art systems, as most suppliers of goods or services, in particular on the Internet, are equipped with such servers. Frequently, they already use point to point secure transfer protocols.

If the supplier of goods or services 2 does not have means 23 capable of managing these transactions, it will entrust the service to a third party approved by the authenticating organization 3. Said third party will previously have set up suitable transfer protocols with the authenticating organization 3.

The means 21 and 23 belonging to the authenticating organization 3 are managed by the means 22.

Systems at the ends of the network 300 situated at the authenticating organization 3 and the neutral intermediary 4 comprise means 33 and 43 to process the point to point secure transfer information flow.

The authenticating organization 3 also has means 31 forming the authentication server, as well as means 32 allowing management of the set of means 31 and 33.

It will be recalled at this point that the term “authenticating organization” refers to a banking or financial organization and, more generally, to an organization authorized to carry out any authentication.

The neutral intermediary 4 is connected to the means 12 over the network 200 via means 42 forming the server. The means 42 comprise, for example, a telephone server, such as IVR (Interactive Voice Response) means, or their equivalent, which are well known to a person skilled in the art.

The means 42 are capable, for example, of making telephone calls 104, making delayed calls, filtering DTMF codes, and distributing messages and recording calls, as well as all options offered by computer systems coupled to telephony for exchanging information with the user 1. The means 42 are known to a person skilled in the art.

The neutral intermediary 4 is also connected to means 11 over the network 100 via means 41 forming the server. The means 41 comprise, for example, a web server.

Finally, the neutral intermediary 4 is connected to the means 33 over the network 300 via means 43 forming the point to point server.

A complementary part of the confidential data can be sent via the supplier of goods and services 2 and this is often done, but it is not essential to the functioning of the present method, which is not based on the security of said transmission channel, and can therefore advantageously be done directly to the authentication organization 3.

In the present description, the term “confidential information” designates all types of confidential alphanumeric, digital or binary codes and/or information linked to a secret identification or transmission. This may be, for example, but not limited to, a payment card number or an authentication code specific to a security system.

Preferentially, the part of the confidential information sent by the telephone system is digital in the current state of the art. The other part of the confidential information is preferably alphanumeric if this is supported by the networks.

The terms “start of the confidential information” and “end of the confidential information” or, more generally, “part of the confidential information”, designate two disjointed parts of the confidential information. The disjointed parts have no meaning when they are taken separately and cannot be reconstituted in a method according to the invention, as they pass by different paths and are reconstituted only by the authenticator organization 3.

The size of the different parts is immaterial, as both parts are strictly complementary and have no meaning in terms of identification or confidentiality when they are taken separately. Therefore, it is not essential that they are the same size.

Preferentially, in one possible implementation of the method, two parties are used, i.e. the supplier of goods or services 2 and the neutral intermediary 4, for sending confidential information between the user 1 and the authenticating organization 3.

The supplier of goods or services 2 and the neutral intermediary 4 are in communication with the user 1 via two communication modes using, for example, different communication technologies or protocols, the Internet network 100 and the telephone network 200 respectively.

Thus, each sends one of the two parts of the confidential information to the authenticating organization 3 via the network 300.

The information flows exchanged between the various parties are represented diagrammatically by the double arrows 101, 102, 103, 104, 105 and 106.

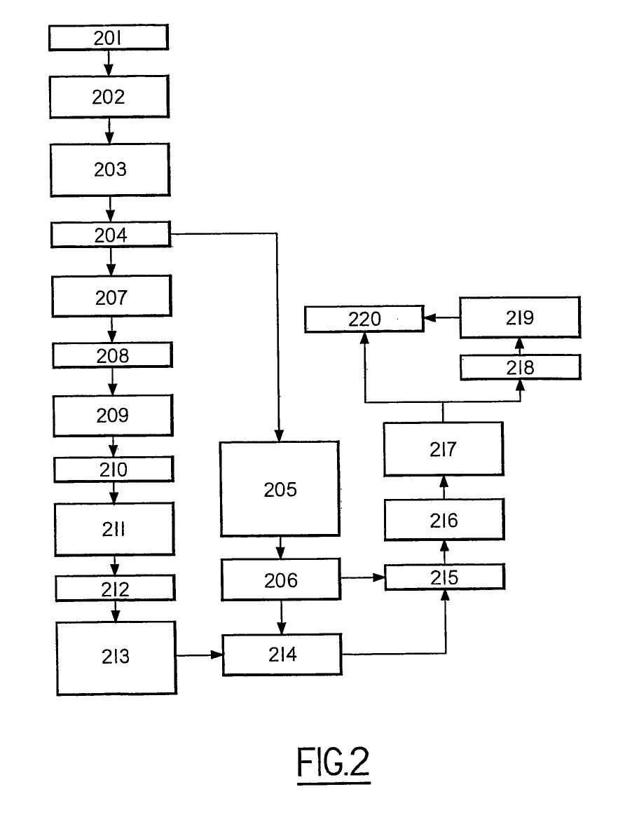

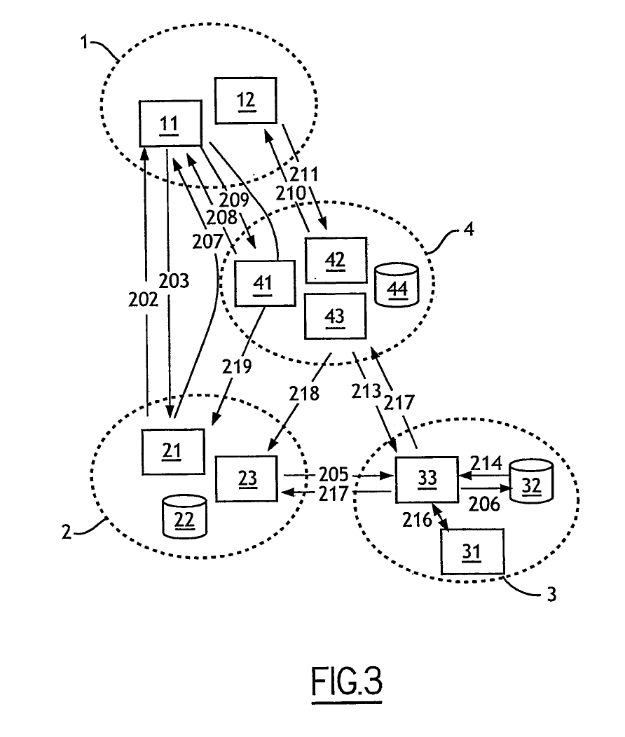

The flows are described in more detail in FIG. 3, which uses the same numbering as FIGS. 1 and 2 for identical items.

FIGS. 1 and 3 represent possible implementation modes for the invention, in which the various players are different entities.

However, it is possible for the transmission path from user 1 to the authenticating organization 3 via the supplier of goods or services 2 to be simplified if the confidential information is sent directly between the user 1 and the authenticating organization 3. In this case, the means belonging to parties 2 and 3 are grouped together in the authenticating organization 3. In this case, the different servers presented as useful for carrying out the method can function on the same means or even be integrated into a single programme. The transfer modes between the various players remain the same as those shown in FIGS. 1 and 3.

In fact according to this method, it is the path via the neutral intermediary 4 which is essential to ensure the securing of the transmission of the confidential information.

No prior registration of the user 1 is necessary in any of the modes for implementing the method according to the invention.

The invention can be used for e-commerce transactions and, more generally, for any data authentication and transfer method.

Advantageously, the method comprises stages according to which:

The user 1 separates the confidential information into two complementary and distinct parts, where neither can be used independently of the other;

The user 1 sends each of the two parts of the code via distinct communication means, via the network 100 to the supplier of goods and services 2, and via the network 200 to the neutral intermediary 4. In the present description, one part of the confidential information is sent to the supplier of goods and services 2, for example, via an Internet network and the other part of the confidential information is sent to the neutral intermediary 4, for example, via a telephone network. Advantageously, the information sent over the networks is not reconcilable by a third party. This makes pirating and eavesdropping of the communications worthless.

The supplier of goods and services 2 and the neutral intermediary 4 send the authenticating organization 3 the part of the code which has been sent to them by the user 1.

Therefore, in the method according to the invention, only the authenticating organization 3 retrieves all the information. Neither the supplier of goods or services 2 nor the neutral intermediary 4 have access to all the information.

The two parts of the information, once reunited by the authenticating organization 3, continue to only pass through private or secure networks which are deemed inaccessible.

Therefore, no intermediary knows all the confidential information, and none can store all the confidential code.

The invention also relates to the use which may be made by the neutral intermediary 4 of the digital fingerprints of pairs formed by the details of user 1 on the network 200, for example the telephone number, and a non-significant part of the confidential data received by the neutral intermediary from the user 1.

During each transaction, the neutral intermediary 4 can store these digital fingerprints in a database or equivalent, for example included in means 44.

Said digital fingerprints are used to build at the neutral intermediary 4 a transactions log, which can be used not only for statistical and reporting purposes, but also, for example, for the purpose of qualifying potential client risk, depending on satisfactory payment or non-payment of the transaction during earlier attempts.

The data is stored in the form of a digital fingerprint, for example by using a mechanism of the MD5 or SHAL type.

The log thus created or the statistical data associated with said log can optionally be provided to the supplier of goods or services 2 or to the authentication organization 3 if a user sends to the neutral intermediary 4 a pair made up of a same information part and by using the same details over the network 200 and the digital fingerprint of which is stored by the neutral intermediary 4. Thus, the intermediary 4 can indicate to the supplier of goods and services 2 if, for example, payment problems are associated to this pair.

Likewise, it is possible to indicate to the supplier of goods or services 2 or to the authenticating organization 3 whether it is the first time that such a pair has been entered.

Therefore, the transactions which present a risk are indicated to the supplier of goods or services 2 or the authentication organization 3.

In any case, the fact that a telephone number, which is relatively easy to trace, must be provided in the preferred mode of implementation, discourages a certain type of dishonest client.

The neutral intermediary 4 does not store uncoded coordinates of user 1 on the network 200, other than coordinates on a list of banned numbers, such as, for example, public telephone boxes or numbers used by potential fraudsters, or deemed to be at risk. Potentially, it will be impossible to send any information from these coordinates.

It is therefore possible to secure transactions and to reduce insurance premiums for policies which the supplier of goods and services 2 is frequently induced to contract in the situation according to the prior art.

The various stages of the method according to the invention will now be described in detail. The following example is one integration possibility but does not cover the entire scope of the possible applications of the method. For example, this example involves payment for on-line purchases by payment card, but it could also involve any authentication, not necessarily for a purchase. Thus the code to be sent does not have to be a payment card number.

FIG. 2 shows a mode for implementing a transaction over a first network of the Internet type and a second of the telephone type.

FIG. 3 shows diagrammatically and with the same reference numbers, the flow of information being exchanged between the various parties while implementing the method according to the stages in FIG. 2.

At stage 201 of FIG. 2, after having selected, for example, items in the catalogue of a supplier of goods or services 2, the user 1 decides to approve his shopping basket.

At stage 202, during the order approval process, the supplier of goods or services 2 requests the user 1 to send it the information necessary for despatch of and payment for the ordered goods.

Among this information, the supplier of goods or services 2 asks only, for example, for the first eight digits of the payment card number of the user 1. The transaction is preferably carried out in secure SSL type mode.

At stage 203, the user 1 sends the information requested by the supplier of goods or services 2.

At stage 204, the supplier of goods or services 2 generates a session identifier. This is an identifier specific to the transaction. It will allow the various parties to exchange information relating to this transaction. This identifier, according to a variant, is generated by the authenticating organization 3 in response to the request from the supplier of goods or services 2, during the stages 205 or 207 detailed below.

At this stage, the supplier of goods or services 2 stores the data, pending payment, in a database, for example included in the means 22, with, for example, the session identifier for the key.

At stage 205, the supplier of goods or services 2 sends the authenticating organization 3 the first part of the payment card number, accompanied by the session identifier if it generated same, together with any other data necessary to finalize the transaction with the authenticating organization 3. The other necessary data is, for example, the payment card expiry date, the amount of the transaction, etc.

The data necessary for the authenticating organization 3 is sent in point to point secure mode as shown in FIG. 1.

At stage 206, the authenticating organization 3 stores the data sent by the supplier of goods or services 2 pending additional information from the neutral intermediary 4, using, for example, the session identifier and the identifier of the supplier of goods or services 2 for the key.

Stage 207 runs simultaneously with stages 205 and 206 according to which the user 1 is redirected, according to means well known to a person skilled in the art, to the site of the neutral intermediary 4, by passing the session identifier as a parameter.

According to one variant, if the supplier of goods or services 2 already has the telephone number of user 1 or, if it wants to send the intermediary 4 other information regarding the transaction, such as the language to be used or the number of characters to be retrieved, it can send this in parallel via a point to point secure link 102.

At stage 208, if no telephone number has been sent to it, the neutral intermediary 4 asks the user 1 for a number at which the latter can be contacted immediately. This has to be a fixed or mobile telephone number.

If necessary, and for reasons of convenience and interactivity, the telephone number can be requested from user 1, if it has not been sent earlier during stage 202 and sent by the user 1 at stage 203. In this case, the number is sent to the transaction intermediary 4 during stage 207.

At stage 209, the neutral intermediary 4 manages everything related to the telephone call and this in particular includes detecting incorrect number format or determining that the number is on a list of numbers at risk. In particular, these will be numbers of telephone boxes on public roads, for example, or numbers used during previous attempts at fraud, or deemed to be risky. The neutral intermediary 4 also manages the detection as to whether the line is busy and ascertaining that numbers or international dial codes are non-existent, etc.

Appropriate responses are provided in each case.

For example, user 1 is asked to correct the telephone number. A differed and/or voice-mode call back or a cancellation of the transaction, can be provided.

The neutral intermediary 4 also checks whether the user 1 employs this telephone as access to the Internet network 100. In this case, the user 1 is asked to disconnect from the Internet. He is then called back automatically, for example five minutes later, and guided through stages 210 to 212 in, for example, voice mode.

The voice guidance stage then ends with the despatch of an email, with an address—or URL (Uniform Resource Locator), according to English terminology—included, which allows his transaction to be continued once he is reconnected. According to possible variants, this electronic message or email (in English terminology) is sent on completion of stages 213 to 220, or be replaced by a link during stage 209.

According to a possible variant, if the payment card number of user 1 is not validated by the authenticating organization 3, then the neutral intermediary 4 calls back user 1.

At stage 210, the user 1 receives a telephone call from the neutral intermediary 4. He is guided on his telephone terminal and/or his web terminal. The messages may be coordinated and synchronized between the two networks by the means operated by the neutral intermediary 4.

At stage 211, the user 1 enters on his terminal 12, in our example the telephone, the additional digits of the numbers entered over the network 100, in our example the last eight digits of his payment card number.

He confirms the entry of the numbers on his terminal 12, for example by pressing the ‘#’ key.

If the telephone 12 of user 1 is not a voice frequency equipment, then, in one variant of the method, he can enter the numbers via a voice recognition system.

During stage 212, the neutral intermediary 4 verifies that it has in fact received the correct number of digits, i.e. in our example eight, and the telephone connection over the network 200 is terminated. It optionally prompts the user 1 to correct errors, for example the entry of a number.

The digital fingerprint of the pair formed by the telephone number+the last eight digits of the payment card number is stored and used to identify the user 1 anonymously during subsequent usage.

As a variant, during the first transaction with the neutral intermediary 4, the user 1 enters an additional code called the personal code, either by repeating a code which moreover will be supplied to him, or by composing a code of his choice during the first transaction.

The digital fingerprint of the pair formed by the telephone number+the personal code is stored and used to identify the user 1 anonymously during subsequent usage.

In another variant, the personal code is replaced by a voice signature. At the end of the transaction, the user 1 is asked to pronounce his name. This voice signature is stored and may be used in the event of a dispute.

In yet another variant, the personal code is replaced by a voiceprint, either selected by the user or predefined.

During subsequent uses of the pair formed by the telephone number+the last eight digits of the payment card number, recognized automatically by comparison with the digital fingerprint, the personal code will be requested again and validated by comparing it with the digital fingerprint of the pair formed by the telephone number+the personal code.

At stage 213, the neutral intermediary 4 sends to the authenticating organization 3 the last eight digits received and the session number in point to point secure mode.

During stage 214, the authenticating organization 3 receives the data. Using the session identifier, the authenticating organization 3 retrieves the first eight digits of the payment card number which were stored earlier during stage 206.

During stage 215, the complete payment card number is reconstituted by the authenticating organization 3.

At stage 216, the authenticating organization 3 validates or does not validate the transaction and generates a response.

In 217, the response is sent in parallel by point to point secure transmission 106 to the supplier of goods and services 2 and optionally to the neutral intermediary 4 via a point to point secure transmission 105.

Then, during stage 218, the neutral intermediary 4, optionally sends the telephone number used for the transaction to the supplier of goods and services 2, via a point to point secure transmission 102. This is a valid telephone number linked to the user 1, which therefore constitutes a trace of the user 1. This number is not stored uncoded at the neutral intermediary 4 except in cases of fraud. It is stored incompletely, for example with two digits masked in a trace file held by the neutral intermediary 4 for billing purposes. It is also stored as a digital fingerprint in the means forming the database of the neutral intermediary 4.

In 219, the neutral intermediary 4 terminates the dialogue with the user 1. The user 1 is then redirected, according to means well known to a person skilled in the art, to the site of the supplier of goods and services 2, by passing the session identifier as a parameter.

Finally, in 220, the supplier of goods and services 2 terminates the transaction with the user 1, for example by confirming the transaction.

As indicated above in the description, according to one preferred variant, the neutral intermediary 4 can store a fingerprint of the telephone number+the last eight digits of the payment card number, enabling it to compile an anonymous log of the transactions and associate statistical data to it.

Furthermore, the neutral intermediary 4 may also send in real time to the supplier of goods or services 2 as well as to the authenticating organization 3 a score or various statistics relating to the history of transactions using this pair of telephone number+last eight digits of the payment card number. The information thus sent can allow the supplier of goods or services 2 to decide in real time to terminate or continue the transaction. Fraud is thus limited for the supplier of goods or services 2 and also for the authenticating organization 3.

Thus, the method according to the invention has numerous advantages, in particular the fact that it uses conventional transmission channels which are easily accessible, such as
transmissions over the open Internet network 100, to which access is relatively easy. These transmissions can be optionally secure.
transmissions called point to point between two certified sites which can pass, either via the Internet network using data sealing methods, encryption and/or exchange of keys or certificates, or over other networks, in particular private, guaranteeing point to point confidentiality 300. Said transmissions are private between recognized professionals (authenticating organizations, in particular the banks and their approved service providers).
finally links terminating on the telephone network 200.

Only the final recipient, the authenticating organization 3 has access to all the confidential information.

The intermediary 4 is neutral and knows nothing about the user except his telephone number and it has no need to store this telephone number uncoded or reversibly encrypted.

Advantageously, the neutral intermediary 4 can call users 1 throughout the world. In this case, advantageously, the size of the network 200 is transparent for each user 1. The network 200 is therefore matched to the network 100 which is often on a world scale, in particular for the Internet.

All the stages of the method are automated, without human intervention and are interactive.

In one preferred implementation, throughout the method, the user 1 remains in simultaneous contact on the Internet, via the means 41 of the neutral intermediary 4 and the telephone link 200, with the means 42 of the neutral intermediary 4.

Transactions are extremely secure, owing to the system of calling back the user 1 by the neutral intermediary 4.

The user who is distrustful can memorize the telephone number which has called him back if he has a calling number display, or obtain it from the telephone operator service in order to verify the identity of the calling server.

1. Method for secure and automated transmission of confidential information, in particular an identification code, to an authenticating organization (3) during a transaction with a user (1) according to which a first part of the confidential information is sent to the authenticating organization over a first network, characterized in that it comprises a stage according to which the user (1) sends the second part of the confidential information, complementary to the first part, to a neutral intermediary (4) over a second network (200) disjointed from the first network, the neutral intermediary (4) then sending to the authenticating organization (3), over a third network (300), the complementary part of the confidential information which it has received.

2. Method according to claim 1, characterized in that the two complementary parts are entered on disjointed terminals.

3. Method according to claim 1, characterized in that the transmission of the first part of the confidential information to the authenticating organization (3) is carried out directly between the user (1) and said organization (3) over the first network.

4. Method according to claim 1, characterized in that the transmission of the first part of the confidential information to the authenticating organization (3) is carried out in the following stages:
the user (1) sends the first part of the confidential information to a supplier of goods or services (2) over the first network (100);
the supplier (2) then sends the first part to the organization (3) over a third network (300).

5. Method according to claim 1, characterized in that at least one session identifier, shared between at least two of the parties (1, 2, 3, 4) to the transaction, allow the authenticating organization (3) to reconstitute automatically the confidential information which the user (1) sends to it.

6. Method according to claim 5, characterized in that each session identifier is generated by at least one of the parties (1, 2, 3, 4) to the transaction.

7. Method according to claim 1, characterized in that coordinates for calling back the user (1) over the second network (200) are sent to the neutral intermediary (4) by the authenticating organization (3) over the third network (300).

8. Method according to claim 1, characterized in that coordinates for calling back the user (1) over the second network (200) are sent to the neutral intermediary (4) by the supplier (2) of goods or services over the third network (300).

9. Method according to claim 1, characterized in that the communication over the first network (100) between the user (1) and the authenticating organization (3) or the supplier of goods or services (2) is transferred automatically to the neutral intermediary (4) for the transaction.

10. Method according to claim 9, characterized in that coordinates for calling back the user (1) over the second network (200) are sent to the neutral intermediary (4) by the user (1) over the first network (100).

11. Method according to claim 1, characterized in that the neutral intermediary (4) contacts the user (1) automatically over the second network (200) to retrieve the second complementary part of the confidential information.

12. Method according to claim 1, characterized in that the user (1) contacts the neutral intermediary (4) over the network (200) to send the second complementary part of the confidential information, associated with a session identifier.

13. Method according to claim 1, characterized in that the third network (300) is a secure point to point network.

14. Method according to claim 1, characterized in that the neutral intermediary (4) requests the user (1) to provide, in addition to the confidential information to be sent to the organization (3), a personal code which allows the user (1) to be identified.

15. Method according to claim 14, characterized in that the personal code is sent, via a secure point to point network, to a second authenticating organization with which the user (1) has previously registered or to which the user (1) is known.

16. Method according to claim 14, characterized in that the personal code is a digital or voice code entered on a connected terminal (12).

17. Method according to claim 9, characterized in that the user (1) is automatically guided by the neutral intermediary (4) through the various stages of the method for sending the second part of the confidential information over the first (100) and/or second (200) network respectively, in a coordinated and optionally synchronized manner.

18. Method according to claim 1, characterized in that the user (1) is automatically guided by the various parties (2,3,4) to the transaction through the various information exchange stages over the first (100) and/or second (200) networks respectively, in a coordinated and optionally synchronized manner.

19. Method according to claim 1, characterized in that the neutral intermediary (4) and/or the organization (3) store(s) the coordinates of user (1) in an uncoded or reversibly encrypted manner.

20. Method according to claim 1, characterized in that the neutral intermediary (4) and/or the organization (3) store(s) in an uncoded or reversible encrypted manner the second complementary part of the confidential information supplied by the user (1) over the network (200).

21. Method according to claim 14, characterized in that the neutral intermediary (4) and/or the organization (3) store(s) the personal code sent by the user (1) in an uncoded or reversible manner.

22. Method according to claim 1, characterized in that the neutral intermediary (4) and/or the organization (3) establish a transaction log.

23. Method according to claim 22, characterized in that the log established by the neutral intermediary (4) and/or the organization (3) is anonymous.

24. Method according to claim 23, characterized in that the anonymity of the log is ensured by a non-decipherable coding of a combination of the coordinates of the user (1) sent over the second network (200) and of the second part of the confidential information sent by the user (1) to the neutral intermediary (4) over the second network (200).

25. Method according to claim 14, characterized in that the personal code is stored, optionally in combination with the coordinates of the user on the network (200) by means of an undecipherable coding.

26. Method according to claim 22, characterized in that the neutral intermediary (4) sends an advice linked to the transaction log of the user (1) over the network (300).

27. Method according to claim 7, characterized in that the neutral intermediary (4) contacts the user (1) again after the latter has disconnected from the first network (100), said connection to the first network (100) being re-established once the second part of the confidential information has been sent to the neutral intermediary (4).

28. System for securely transmitting confidential information, in particular an identification code, to an authenticating organization (3) during a transaction, comprising means at the location of a user (1) in a transaction with means at an authenticating organization (3) and/or means (21) at a supplier (2) of goods or services, and means (41) at a neutral intermediary (4), characterized in that the means at the location of user (1) comprise means (11) capable of sending a first part of the confidential information to means (21) at the supplier (2) of goods or services or at the organization (3) over a first network (100), means at the location of the user (1) also comprising means (12) capable of sending the second complementary part of the confidential information to means (42) at the neutral intermediary (4) over the second network (200), the means at the neutral intermediary (4) and/or the means at the supplier (2) further comprising means (23, 43) capable of sending the part of the code which they have received to means (33) at the authenticating organization (3).

29. System according to claim 28, characterized in that the first (100) and second (200) networks are disjointed.

30. System according to claim 29, characterized in that the first (100) and second (200) networks use different communication technologies and protocols.

31. System according to claim 28, characterized in that the entry means (11) on the first network (100) are independent of the entry means (12) on the second network (200).

32. System according to claim 28, characterized in that the authenticating organization (3), the neutral intermediary (4) and/or the supplier (2) of goods or services comprise means capable of generating or managing at least one session identifier for exchanging and/or retrieving information concerning the transaction and allowing the authenticating organization (3) to reconstitute the confidential information sent by the user (1) via the entry means (11,12) over the first and second networks (100, 200).

33. System according to claim 28, characterized in that the neutral intermediary (4) comprises means (42, 44) capable of automatically contacting the entry means (12) of the user (1) over the second network (200) so that the user sends the second part of the confidential code.

34. System according to, claim 28 characterized in that the neutral intermediary (4) comprises means capable of generating digital fingerprints or unidirectional encryption.

35. System according to claim 28, characterized in that the supplier of goods or services comprises means capable of transferring the communication over the first network (100) between the means of entry (11) at the location of the user connected to server-forming means (21) at the supplier to server-forming means (41) at the neutral intermediary (4), thus automatically connecting the user (1) to the neutral intermediary (4) and thus enabling the two parties to interact.

36. System according to claim 28, characterized in that the supplier (2) of goods or services, the authenticating organization (3) and the neutral intermediary (4) comprise means (23,33,43) allowing the transmission of secure point to point data over a third network (300).

37. System according to claim 28, characterized in that the neutral intermediary (4) has means (41, 42, 43, 44) enabling it to coordinate and/or synchronize messages over the networks (100, 200 and 300).

38. Systems according to claim 28, characterized in that the neutral intermediary (4) and/or the authenticating organization (3) comprise(s) means (44) capable of storing information supplied by the user (1) and system utilization statistics.

39. System according to claim 28, characterized in that the neutral intermediary (4) comprises means (42) capable of voice recognition and/or voice synthesis.

40. System according to claim 28, characterized in that the user (1) comprises means (12) capable of automatically contacting the server-forming means (42, 44) of the neutral intermediary (4) over the second network (200) in order to send the second part of the confidential code.

41. System according to claim 28, characterized in that the neutral intermediary (4) comprises means capable of being contacted by the user (1) over the second network (200) to enable the transmission of the second part of the confidential information.

42. System according to claim 28, characterized in that the neutral intermediary (4) and/or the organization (3) comprise(s) means capable of identifying the user in a log using the confidential code sent during the transaction.

43. System according to claim 28, characterized in that from its privileged position, the authenticating organization (3) also comprises the means of the neutral intermediary (4).
